(19) United States
(12) Patent Application Publication
(10) Pub. No.: US 2022/0343311 A1
(43) Pub. Date: Oct. 27, 2022

(54) Method for Payment Transaction Execution Using Customer's Mobile Device

(71) Applicant: Joint Stock Company ‘BISMART’, Minsk (BY)

(72) Inventor: Roman V. Souchtchinski, Minsk (BY)

(73) Assignee: Joint Stock Company ‘BISMART’, Minsk (BY)

(21) Appl. No.: 17/638,815

(22) PCT Filed: Sep. 5, 2019
(86) PCT No.: PCT/BY2019/000011

§ 371 Date: Feb. 26, 2022

(51) Int. Cl. G06Q 20/32; G06Q 40/02; G06Q 20/40; G06Q 20/42

(52) U.S. Cl. CPC G06Q 20/3223; G06Q 40/02; G06Q 20/40; G06Q 20/3274; G06Q 20/42

(57) ABSTRACT

A method for payment transaction execution using a customer's mobile device of the present invention, includes activation of the mobile application by the customer on their mobile device, authentication of the customer at the bank via the mobile application, receipt of information from the seller using the computerized cash desk system and cash desk server, creation of the payment authorization request with the use of information about the customer, the seller, and the payment, sending payment authorization request to the customer, and receipt of the result of the payment authorization request from the customer. Upon activation of the mobile device and authentication of the customer at the bank, the dynamic code identifying the customer at given point in time is created on the mobile device screen.

This invention relates to the area of executing financial operations mainly related to payment for goods or provided services by means of cashless transfer of funds between accounts of the customer (sender) and the seller (recipient).

At present, when information technologies become more and more integrated into our life, opportunities to satisfy certain demands of people become more universal. Using identifying information in various spheres of life may serve as an example.

Today, the possibility to pay for acquired goods and services via seller's terminals is becoming especially popular all over the world. Not only money but also various identifying information carriers may be used as the payment method. An important role in such operations belongs to optimization of interaction between the customer and the seller of goods and services via the seller's terminal, and preciseness, completeness and protection of information identifying the payment and acquired goods and services.

The systems of payment for goods/services sold via seller's terminals are widely known, e.g. [U.S. Pat. No. 8,348,155 published on 26 Mar. 2009], [U.S. Pat. No. 8,600,883 published on 19 Jul. 2012], [U.S. Pat. No. 8,438,063 published on 1 Mar. 2012].

As a rule, all such systems provide for payment with money or card, or using mobile devices, when in the result of interaction between the seller's terminal for sale of goods and services and the payment means the amount paid by the customer is accepted as payment for the goods, or the respective purchase amount is debited from the customer's account identified with a card or a mobile device. The payment means itself does not store information about the amount paid for the goods (or contains the balance of funds after debit, at the best) or the goods/services purchased, has insufficient degree of protection, and depends on availability of a mobile device at the customer's disposal and reliability of cellular conditions at the place of sale of the goods and services via the seller's terminal.

The nearest prior art reference to the invention claimed is the method of payment transaction with the use of a mobile device [4] including activation of the mobile application by the customer on their mobile device, authentication of the customer at the bank via the mobile application, receipt of information from the seller using the computerized cash desk system and cash desk server, creation of the payment authorization request with the use of information about the customer, the seller, and the payment, sending payment authorization request to the customer, and receipt of the result of the payment authorization request from the customer. This method includes an additional stage at which the mobile device deletes the card information after sending the payment authorization request to the customer.

A drawback of the known method is insufficient degree of information security, due to which the method includes an additional stage when the mobile device deletes the card information after sending the payment authorization request to the customer.

The aim of this invention is creation of the payment transaction method using a mobile device, providing for high degree of information security without using special devices, encryption keys, etc.

The technical result providing for achievement of the aim mentioned is division of the payment process into two independent components: the customer's authentication in the system and the payment procedure.

The aim mentioned in a method of payment transaction execution using the customer's mobile device including activation of the mobile application by the customer on their mobile device, authentication of the customer at the bank via the mobile application, receipt of information from the seller using the computerized cash desk system and cash desk server, creation of the payment authorization request with the use of information about the customer, the seller, and the payment, sending payment authorization request to the customer, and receipt of the result of the payment authorization request from the customer, is solved as follows.

Upon activation of the mobile device and authentication of the customer at the bank, the dynamic code identifying the customer at the given point in time is created on the mobile device screen, scanned by the computerized cash desk system of the seller and sent to the cash desk server of the seller; the information package is created by the cash desk server for the bank's payment server operating bank information systems; the customer is identified by the payment server operating bank information systems; the payment server forms the payment authorization request to the customer using the information about the customer, the seller, and the payment; the payment server sends the payment authorization request to the customer's mobile device; and after receipt of the payment authorization from the customer, the payment is made to the seller's account and the payment confirmation is sent to the cash desk server of the seller to draw the receipt.

The above-mentioned dynamic code identifying the customer at given point in time can be a QR code or a bar code. The information package for the bank's payment server preferably contains the customer's dynamic code, the purchase amount, ID of the computerized cash desk system of the seller, the time of transaction execution, and the indication of payment with the mobile device.

The payment authorization request for the customer preferably contains the amount of purchase and the information about the seller, and payment authorization from the customer contains selection of the ‘Pay’ option in the mobile application.

This and other indications, aspects and advantages of this invention become clearer on the following figures on which:

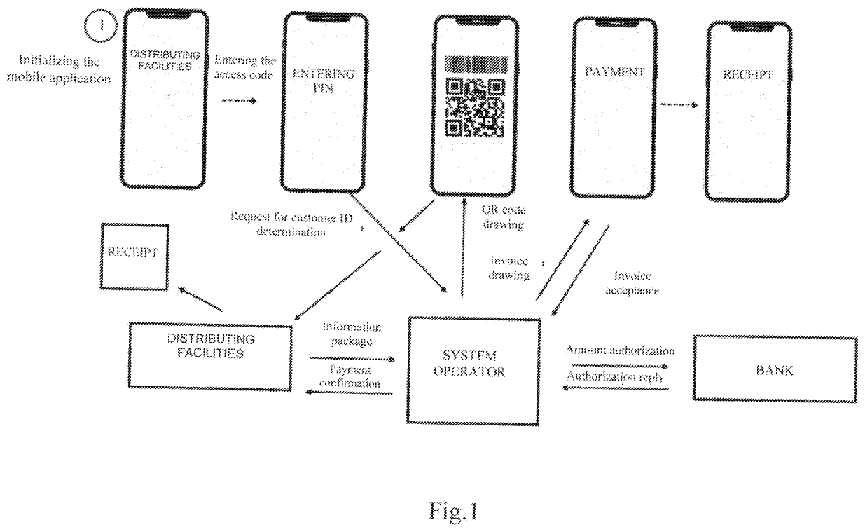

FIG. 1 is the layout of the payment transaction with the use of the mobile device according to this invention.

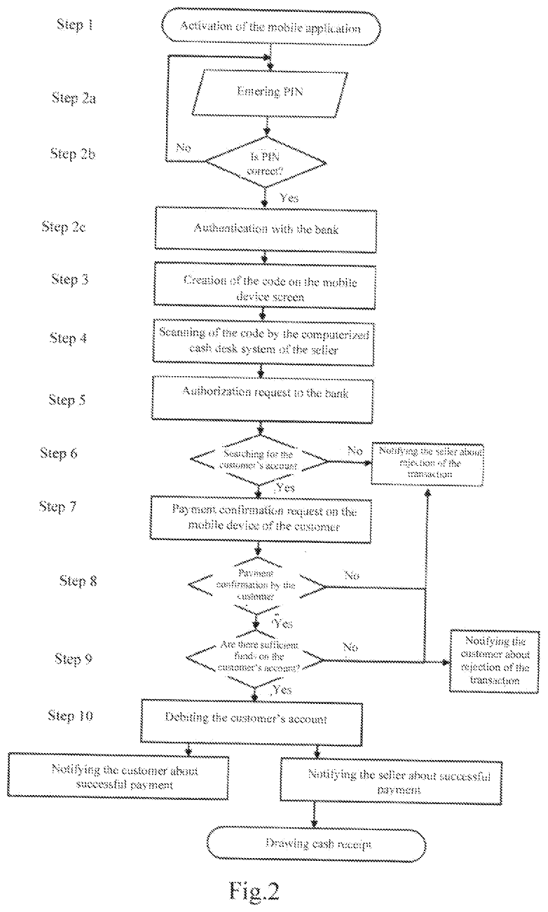

FIG. 2 is the algorithm of the payment transaction with the use of the mobile device according to this invention.

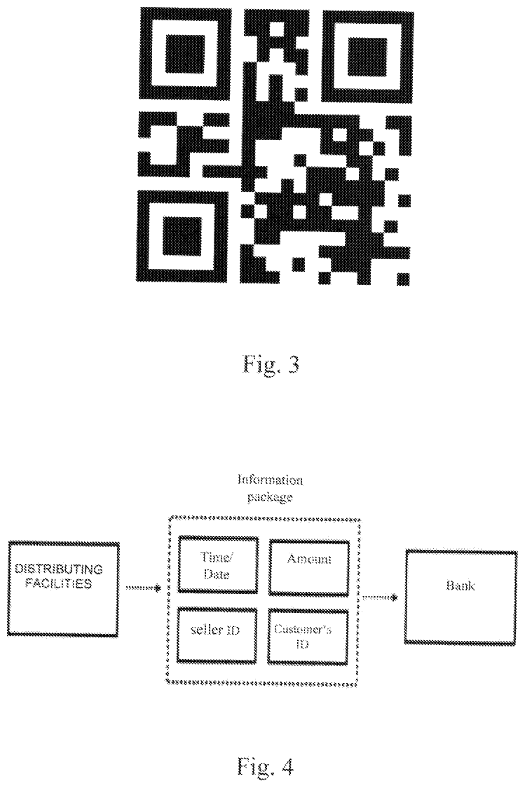

FIG. 3 shows an example of implementation of the dynamic code identifying the customer.

FIG. 4 shows an example of implementation of the information package for the bank's payment server.

The claimed method (see FIGS. 1, 2) is implemented as follows. Step 1—The customer activates the mobile application on their mobile device. Step 2—The customer is authenticated at the bank with the use of the mobile application. Step 2a —The customer enters PIN on their mobile device. Step 2b—The bank validates authentication data of the customer; if the authentication data is invalid, the rejection reply is sent to the customer, otherwise the bank fulfills Step 2c and accepts the customer as authenticated.

Step 3—Upon activation of the mobile application and authentication of the customer at the bank, the dynamic code identifying the customer at the given point in time is formed on the mobile device screen. In the example, the code is a QR code (see FIG. 3), but it can be a bar code (as shown on FIG. 1), if necessary. Step 4—The code is scanned by the computerized cash desk system of the seller and sent to the seller's cash desk. Step 5—The seller makes an authorized request to the bank, preferably via the Internet, for which the cash server forms the information package for the bank's payment server operating bank information systems.

Optimally, the information package for the bank's payment server contains the dynamic code of the customer, the amount of purchase, ID of the computerized cash desk system of the seller, the time of the transaction execution, the indication of payment with the mobile device (see FIG. 4). Interaction of the seller and the bank may be possible via the system operator (see FIG. 1). The SYSTEM OPERATOR is the technical agent routing requests from the seller to the bank using the criteria of attribution of the customer to the bank.

Step 6—The customer is identified by means of search of the customer's account in the bank information system on the payment server. If the customer's account stated in the information package of the customer is not found with the bank, the seller is sent the reply with rejection of the transaction.

Step 7—If the customer's account stated in the information package is available at the bank, the payment authorization request is drawn using the information about the customer, the seller, and the payment. The payment authorization request to the customer is drawn by the payment server. The payment authorization request to the customer contains the amount of purchase and the information about the seller. The payment authorization request is sent by the payment server via the Internet to the customer's mobile device.

Step 8—The result of the payment authorization request from the customer is received by the bank's payment server; payment authorization by the customer includes selection of the ‘Pay’ option by the customer in the mobile application. If payment authorization from the customer is absent within the predetermined time, the message of the transaction rejection is sent to the seller.

Step 9—After receipt of the payment authorization from the customer, the bank checks sufficiency of funds on the customer's account stated in the information package. If funds on the customer's account are insufficient, the message of the transaction rejection is sent to both the seller and the customer.

Step 10—After receipt of the payment authorization from the customer and confirmation of sufficiency of funds on their account, payment is made to the seller's account by debiting the customer's account, and payment confirmation is sent to the customer and to the cash desk server of the seller to draw the receipt.

This, only the bank has access to the customer's banking data, the merchant interacts with the bank only, the payment process is divided into two independent components, providing for high degree of information security without seller use of special devices, encryption keys etc. in the claimed method.

What is claimed is:

1. A method for payment transaction execution using a customer's mobile device, the method including the steps of:
activating of a mobile application by the customer on their mobile device,
authenticating the customer at a bank via the mobile application,
receiving information from a seller using a computerized cash desk system and a cash desk server,
creating a payment authorization request with the use of information about the customer, the seller, and the payment,
sending the payment authorization request to the customer, and
receiving the result of the payment authorization request from the customer, wherein
upon activation of the mobile device and authentication of the customer at the bank, a dynamic code identifying the customer at given point in time is created on the mobile device screen, this code is scanned by the computerized cash desk system of the seller and sent to the cash desk server of the seller
the information package is created by the cash desk server for the bank's payment server operating bank information systems,
the customer is identified by the payment server operating bank information systems,
the payment server forms the payment authorization request to the customer using the information about the customer, the seller, and the payment,
the payment server sends the payment authorization request to the customer's mobile device, and
after receipt of the payment authorization from the customer, the payment is made to the seller's account and the payment confirmation is sent to the cash desk server of the merchant to draw the receipt.

2. The method as set forth in claim 1, wherein the dynamic code identifying the customer at the then current moment of time is a QR code or a bar code.

3. The method as set forth in claim 1, wherein the information package for the bank's payment server contains the dynamic code of the customer and the information about the seller, the purchase amount, ID of the computerized cash desk system of the seller, the time of transaction execution, and the indication of payment via the mobile application.

4. The method as set forth in claim 1, wherein the payment authorization request to the customer contains the purchase amount, and payment authorization from the customer includes selection of the ‘Pay’ option by the customer in the mobile application.
